(19) United States
(12) Patent Application Publication
(10) Pub. No.: US 2019/0375193 A1
(43) Pub. Date: Dec. 12, 2019

(54) INSULATING BUBBLE WRAP

(71) Applicant: SIMPLE CONTAINER SOLUTIONS, INC., Rancho Dominguez, CA (US)

(72) Inventor: Charles Veiseh, Los Angeles, CA (US)

(21) Appl. No.: 16/432,248

(22) Filed: Jun. 5, 2019

Related U.S. Application Data
(60) Provisional application No. 62/681,252, filed on Jun. 6, 2018.

(51) Int. Cl. B32B 15/085; B32B 15/20; B32B 27/32; B29C 51/22; B29C 33/42; B29C 51/30; B65D 81/38; B65D 81/03; B29C 65/00

(52) U.S. Cl. CPC B32B 15/085; B32B 15/20; B32B 27/32; B29C 51/225; B29C 33/42; B29K 2023/0633; B65D 81/3888; B65D 81/03; B29C 66/83413; B32B 2323/046; B32B 2439/70; B29C 51/303

(57) ABSTRACT

An insulating bubble wrap comprising a metallized polyethylene layer having a first metallized side, a second non-metallized side, and a metal thickness; and a polyethylene bubble film cap layer attached to the metallized polyethylene along the second non-metallized side.

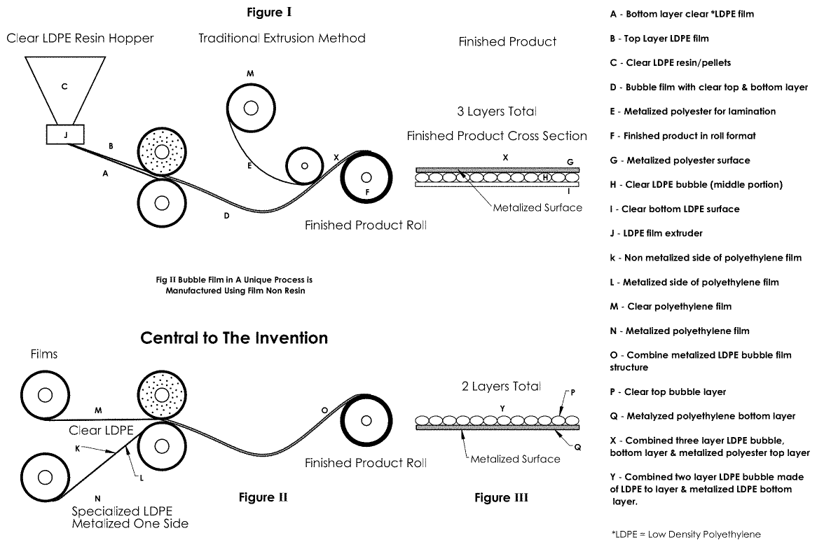

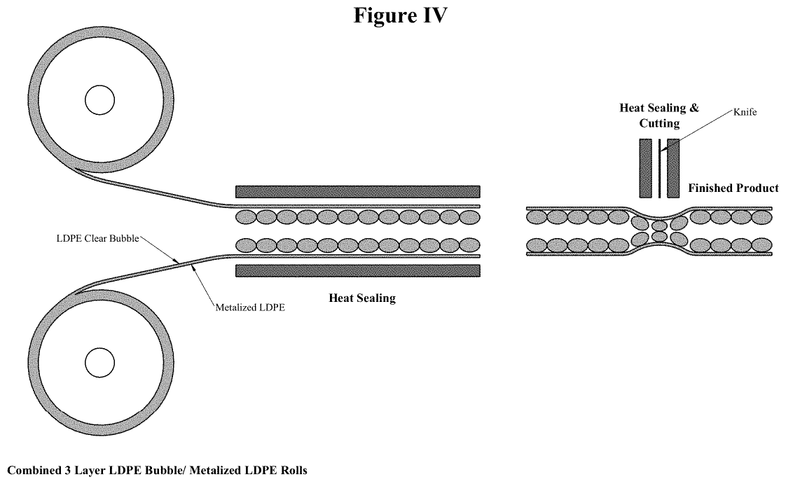

### FIELD OF THE INVENTION

The present invention relates to the field of insulating thermoplastic materials and use of the same for creating low cost, environmentally friendly insulating packaging for the transport of heat or cold sensitive goods.

### BACKGROUND

The shipment of perishable items frequently requires that such goods remain at or near the recommended storage temperature; which can be refrigerated, frozen or at room temperature. Because of lengthy transport times for perishable items and the sensitivity of some goods to adverse ambient temperatures during transport, considerable efforts have been made to create insulated packaging materials with improved insulating characteristics.

Current solutions include insulating roll stock used for wrapping, insulating bags, pouches, box liners, shopping bags or covers; that can work in conjunction with corrugated cartons or envelopes or separately. Such insulating packaging can be manufactured using combined laminated materials such as metallized laminated bubble wrap. The insulating packaging material is typically manufactured using thermoplastics, such as polyethylene bubble wrap that is laminated to metallized polyester film. This material exhibits insulating properties due to the heat reflective properties of the metallized polyester as well as the air encapsulation of the bubble film. The bubble film layer also provides rigidity to facilitate handling and use of the insulating packaging product.

The recent surge in web fulfillment of food and medical products has resulted in increased use of such insulating packaging products. Thus, there is an increased need for environmentally friendly types of such products including those that allow recycling of the same after use or otherwise more favorable disposal.

Households that purchase perishables have been accustomed to and expect that their goods arrive ‘cold packed’ with insulation and refrigerant packs. Metallized film used in packaging applications is a heat reflector used for packaging products in various forms. In fact, the ubiquity of such a material has resulted in contributing to the perception that even when shipped products require lesser levels of protection, when metallized films are used to package them; they communicate that the contents of a package have arrived in protective or insulated packaging, which is a valuable marketing feature.

Further, the increased use of protective packaging and insulating packaging has created interest in the sustainability, compostability and biodegradability of such materials post use. Thus, significant efforts are undertaken to communicate to the end-users of such goods whether they are recyclable; and specifically, what sort of facility is needed for their recycling. Visual cues are often printed onto such packaging, preferably using ink printing, to signal various meanings to the reader. Such printing includes the term “Recyclable #4,” or recycling symbols indicating low density polyethylene film, which is a common symbol for curbside recyclability. The cue “Recyclable #7” or a symbol meaning the same, communicates that mixed plastics are involved that may require processing in a special recycling facility. These markings can also act as identifiers to be used by recycling facilities to ascertain the nature of the materials in some packaging products, and can also identify appropriate recycling methods or facilities. Examples of mixed plastics are articles such as bags and pouches containing polyester films combined with polyethylene sealant layers.

The use of such markings is highly valuable in the marketability of packaging products, in that they communicate a level of sustainability that can be highly desirable to the end-user. In general, mixed plastics tend to have lower value to the recycler compared to non-mixed plastics.

Although insulating packaging products, such as polyethylene bubble laminated to metallized polyester, are effective, they are manufactured using dissimilar thermoplastic materials. Specifically, low density polyethylene and polyester differ in chemical makeup, and exhibit different physical characteristics, including melt points. For example, polyester film has a melting point in the range of 492.8° F.-518° F., while typical low density polyethylene bubble has a melting point in the range of 221° F. to 225° F. being low to 230° F. to 239° F. in the high range. Thus, insulating bags, pouches, box liners, shopping bags or pallet covers made of this combined material require special recycling after use at a facility that accepts mixed plastics of differing plastic type and melting point. This represents a recycling process that can be very tedious, especially in light of the limited access households have to such facilities.

Additionally, when considering the manufacture of the polyester film used in metallized form described in the mixed plastic product above, a specialized extrusion process is required, making customization and the addition of necessary additives more tedious. Such additives include those that promote biodegradation, oxo-biodegradation and/or promote compostability. Otherwise, they promote decreased volume after disposal. All such features would contribute to making such products more environmentally friendly.

There exists a strong demand for low cost, environmentally friendly and easily recyclable insulated packaging that can be used to transport temperature sensitive goods. Thus, the development of improved bubble wrap insulation material has continued.

### SUMMARY OF THE INVENTION

The subject matter of the present disclosure relates to improved polyethylene bubble wrap insulation material and methods for its manufacture.

In one embodiment, the present disclosure provides an insulating bubble wrap comprising a metallized polyethylene layer having a first metallized side, a second non-metallized side, and a metal thickness; and a polyethylene bubble film cap layer attached to the metallized polyethylene along the second non-metallized side.

In another embodiment, the present disclosure provides a process for producing a bubble wrap comprising: (1) feeding a first polyethylene film to a heated roll system comprising a first vacuum roller comprising dimples and a second roller, wherein the first vacuum roller contacts the first polyethylene film, thereby forming a bubble layer having a top side and an unsealed bottom side; and (2) feeding a metallized polyethylene film comprising a first metallized side and a second non-metallized side to the heated roll system, wherein the second non-metallized side contacts the unsealed bottom side of the bubble layer, thereby forming a sealed bubble layer comprising a top side.

In still another embodiment, the present disclosure provides an article comprising the insulated bubble wrap, the article being selected from pouches, box liners, pallet covers or shopping bags. The insulated bubble wrap comprises a metallized polyethylene layer having a first metallized side, a second non-metallized side, and a metal thickness; and a polyethylene bubble film cap layer attached to the metallized polyethylene along the second non-metallized side.

In another embodiment, the present disclosure provides a process for preparing an article comprising an insulated bubble wrap, the article being selected from pouches, box liners, pallet covers or shopping bags. The insulated bubble wrap comprises a metallized polyethylene layer having a first metallized side, a second non-metallized side, and a metal thickness; and a polyethylene bubble film cap layer attached to the metallized polyethylene along the second non-metallized side.

### BRIEF DESCRIPTION OF THE DRAWINGS

The subject matter of the present disclosure will be more fully understood from the following detailed description, taken in connection with the accompanying drawings, in which:

Figure I illustrates a conventional manufacturing process of a three-layer metallized bubble film, starting with the extrusion of polyethylene film for both the top and bottom layer and lamination of metallized polyester on top.

Figure II illustrates the special manufacturing method wherein a metallized polyethylene film is combined with a polyethylene bubble cap in a unique bubble film manufacturing process.

Figure III Illustrates the preferred structure of the recyclable insulating material.

Figure IV illustrates the converting process where such a finished combined insulation material is converted into a flat pouch.

### DESCRIPTION OF THE INVENTION

It has unexpectedly been found that an improved insulating material facilitates recycling of the material when discarded. Such insulating material can be utilized to manufacture insulating packaging products such as insulating wrapping material, box liners, pouches, shopping bags or pallet covers with the same advantages. Unlike traditional metallized laminate packaging products, non-dissimilar plastic types are used to manufacture the material, and this allows for easier recycling after use. Also, such materials may be more easily customized to contain additives facilitating the breakdown after use of a majority of the structure.

In one embodiment, the present disclosure provides an insulating bubble wrap comprising a metallized polyethylene layer having a first metallized side, a second non-metallized side, and a metal thickness; and a polyethylene bubble film cap layer attached to the metallized polyethylene along the second non-metallized side. The bubble wrap thus preferably is a two-film system, where a sealed bubble side of a first film faces outward on one side, and the metallized side of the second film faces outward on the other side, and where the non-metallized side of the second film serves as the seal for the bubble layer. The metallized films described in the current subject matter are generally heat sealable only on the opposite side and where the bubble is attached.

Metallized Polyethylene Layer

The metallized polyethylene layer described in the present disclosure is metallized on one side and non-metallized on the other, and is a polyethylene having a density of 0.910 to 0.965 g/cc. Preferably, the polyethylene used in the metallized layer is a low-density polyethylene having a density of 0.910 g/cc to 0.925 g/cc, a linear low density polyethylene having a density of having a density of 0.910 to 0.940 g/cc, a medium density polyethylene having a density of 0.926 to 0.940 g/cc, or a high density polyethylene having a density of 0.941 to 0.965. The polyethylene used in the metallized layer can also be a mixture of two or more of the low density, linear low density, medium density and high density polyethylenes. Preferably, the polyethylene is a blend of a linear low density polyethylene containing hexene or butene and low density polyethylene. The polyethylene can be a homopolymer of ethylene or a copolymer of ethylene with an alpha-olefin CH₂═CHR, wherein R is an alkyl radical containing from 1 to 18 atoms of carbon. Preferably, when the polyethylene of the metallized layer is a copolymer, R is an alkyl radical containing from 1 to 8 carbon atoms. More preferably, R is an alkyl radical containing 1, 2, 4, or 6 carbon atoms. Even more preferably, the alpha-olefin is hexene. In addition to providing heat reflective properties to a film layer, metallization has an added benefit in that it also makes articles made of the material ideal for protection of electronics, such as circuit boards, that are sensitive to electrostatic discharge. Alternatively, one or more layers of base, bubble or laminate top layer of film used in the structure may use films that provide electrical conductivity and/or antistatic properties. Articles made of such structures can provide protection to sensitive electronic products while still providing the benefit of easily recyclable material not manufactured from mixed plastics.

Preferably, the melting point of the polyethylene used in the metallized polyethylene layer is from 221° F. to 400° F. More preferably, the melting point is from 222° F. to 300° F., even more preferably, from 223° F. to 250° F. Still more preferably, the melting point is from 224° F. to 239° F. Most preferably, the melting point is 225° F. to 235° F. Unless stated otherwise in this specification, the properties of polyethylene, such as melting point, are those of the polyethylene material itself, as described above, without any additives.

The polyethylene used in the film for the metallized film layer can generally be manufactured using any type of polyethylene catalyst, such as Ziegler or Single-Site catalysts known to those skilled in the art, in any suitable reactor system. Preferably, when a single-site catalyst is used the catalyst is a metallocene catalyst. Films having the melting point ranges described above represent a cost-effective method to produce material having greater rigidity and better heat resistance, making them ideal for converting where the web of material requires some stiffness and heat sealing where the material needs to remain relatively stable when heat is applied, exhibit improved mechanical cutting characteristics. Other processes to create films with improved heat resistance and stiffness which exhibit melt characteristics outside a reasonable margin of the remainder of the film construction may not prove cost effective.

The melt characteristics of the polyethylene films of the present subject matter facilitate the formation of the cushion forming process, such as bubble wrap manufacturing, by maintaining the stability of the film during heating and stretching, as well as the downstream converting process, by providing better heat seal properties. Specifically, since high heat is typically used for mass production of packaging products, a low melt resin may prematurely melt and/or exhibit poor heat sealing when used in such a process. Resin types exhibiting good heat seal properties, e.g., hexene-containing copolymers tend to have melt points in the higher range for films made of polyethylene. The development and use of this specialized film with the polyethylene materials discussed above enable the manufacture of metallized thermoplastic films of similar chemical origin to the film type used in the combining bubble wrap forming process, and contribute to a combined structure that is more easily recyclable while not requiring a mixed plastics label. Further, when additives are included in the specialized film, the end products made of such a material may partially break down and biodegrade more rapidly if discarded in the proper environment.

Preferably, the polyethylene used in the metallized polyethylene layer is metallized on one side of the layer, and non-metallized on the other. The metal used in the metallization is preferably aluminum. The metallization can be conducted in any manner well known to those in the art. Preferably, the method is by vacuum deposition. The thickness layer of the metal on the film after metallization is preferably 2 to 100 micron. More preferably, the thickness of the layer is 5 to 75 micron. Most preferably, the thickness is 10 to 50 micron.

The metallized polyethylene layer preferably has a thickness greater than 0.5 mil, more preferably from 0.7 to 2.5 mils. Even more preferably, the thickness of metallized polyethylene layer is from 0.75 to 0.95 mils. Most preferably, the thickness of metallized polyethylene layer is from 0.80 to 0.90 mils.

The metallized polyethylene layer can be manufactured by starting with a polyethylene film. When the metallized polyethylene layer is tinted, preferably, it is tinted white.

The metallized polyethylene films described above produced from resins with melt characteristics in the range of the polyethylene films described above, can be treated using methods such as “corona treating,” a process used to prepare the surface of a plastic film for adhesion or metallizing. It is a treatment that prepares the surface of a plastic film for adhesion. Film surfaces ideal for metalizing are generally free of materials, treatment or other properties, that can disturb the metallizing process. Additionally, such films are also generally free of surfactants, anti-block agents, slip materials and other materials that may interfere with the metallization process of such specialized films. Specialized process additives such as packaged surfactants may be utilized to facilitate manufacturing. Preferably, the thickness of the film material is as described above since the corona treatment is conducted at approximately 40 or above ‘dyne’ levels, to prevent the transfer of the corona treatment to the opposite surface of the film.

Films for metallizing preferably have a level of gloss as measured by ASTM D2457-13 at a 60 degree angle, in the range of 15 to 60. More preferably, the gloss is 45 to 60.

Other film treatments to prepare the preferred film for metallizing are ‘chemical’ and ‘plasma’ treatments.

Polyethylene Bubble Film Cap Layer

The polyethylene used in the bubble film cap layer of the current subject matter is a polyethylene having a density of 0.910 to 0.965 g/cc. Preferably, the polyethylene used in the bubble film cap layer is a low-density polyethylene having a density of 0.910 g/cc to 0.925 g/cc, a linear low density polyethylene having a density of having a density of 0.910 to 0.940 g/cc, a medium density polyethylene having a density of 0.926 to 0.940 g/cc, or a high density polyethylene having a density of 0.941 to 0.965. The polyethylene used in the bubble film cap layer can also be a mixture of two or more of the low density, linear low density, medium density and high density polyethylenes. Preferably, the polyethylene is a blend of a linear low density polyethylene containing hexene or butene and low density polyethylene. The polyethylene can be a homopolymer of ethylene or a copolymer of ethylene with an alpha-olefin CH₂═CHR, wherein R is an alkyl radical containing from 1 to 18 atoms of carbon. Preferably, when the polyethylene of the bubble film cap layer is a copolymer, R is an alkyl radical containing from 1 to 8 carbon atoms. More preferably, R is an alkyl radical containing 1, 2, 4, or 6 carbon atoms. Even more preferably, the alpha-olefin is hexene.

Preferably, the melting point of the polyethylene used in the metallized polyethylene layer, is from 221° F. to 400° F. More preferably, the melting point is from 222° F. to 300° F., even more preferably, from 223° F. to 250° F. Still more preferably, the melting point is from 224° F. to 239° F. Most preferably, the melting point is 225° F. to 235° F.

The polyethylene bubble cap film layer preferably has a thickness of greater than 0.5 mil, more preferably, 1.0 to 2.5 mils. Even more preferably, the thickness of polyethylene bubble cap film layer is from 1.0 to 1.2 mils.

Preferably, the polyethylene bubble film cap layer is non-tinted. If the bubble film cap layer is tinted, preferably, the tint is white.

Insulating Bubble Wrap

The insulating bubble wrap manufactured according to the present subject matter exhibits insulating properties and is environmentally friendly due to the chemical identity or additives contained in the thermoplastics used in its manufacture.

Various articles can be produced using the insulated bubble wrap of the current subject matter. Preferably, the article is selected from pouches, box liners, pallet covers or shopping bags. Film material used in a structure must withstand the rigors of heat-sealing while remaining intact and not melting prematurely when heat is applied, i.e. when used in a converting process creating insulating box liners, pouches and other packaging products. Packaging articles made using the material of the current subject matter preferably have bubbles popped, unmade or otherwise flat in the lip of the closure area, in order to provide a generally airtight seal when overlapping or abutting the material during closure

Additionally, it's important to note that conventional insulating bubble wrap made of chemically dissimilar thermoplastics such as polyethylene bubble laminated to metallized polyester are typically manufactured using four layers at a minimum, i.e. a base layer, bubble cap layer and a laminate top layer that is itself coated with a fourth layer of sealant. It is important to note that traditional bubble wrap laminated to metallized polyester is typically manufactured in an inline process (see Figure I) where thermoplastic resins are processed by an extruder and first formed into film layers/webs that are further processed using heat, vacuum forming and combining into bubble wrap. The bubble wrap is then fed to a lamination process where it is laminated to metallized polyester film coated with polyethylene, usually on the top bubble surface. Such a process joins dissimilar plastic types, namely polyester and low-density polyethylene films, creating a mixed plastics product and resulting in downstream products that are relatively difficult to recycle. Further, when using dissimilar plastics, a sealant (coating) layer must be used to allow the heat sealing and bonding of the two materials, which introduces increased layers with added cost and other disadvantages. Metallized polyester used in such structure is commonly coated with a layer of polyethylene.

In contrast, the disclosure of the present subject matter introduces efficiency by teaching a method that reduces the necessary layers of film by employing the use of a metallized bottom layer that will serve as the exterior of the insulating material and downstream packaging products as well as the base layer of bubble film. The result is that the reflective layer that is laminated to the top of the cap layer is no longer necessary, since the bottom layer serves as both the base of the bubble film as well as the reflective surface. This introduces significant efficiencies due to the reduction of plastic material; specifically, the removal of an entire layer of dissimilar plastic material needed in producing conventional insulating packaging described above. Also, as seen in Figure II, since the bubble cap film layer is often clear polyethylene film where the surface of the base layer is exposed as it is unwound, but before the cap layer is laid onto it, a printing process can be utilized where the helpful recycling symbols described above, and the information can be printed onto the non-metalized side of the base layer that is visible through the preferably clear bubble layer. This provides helpful and valuable cues for marketing and for end-users and recyclers of discarded packaging product made of the material.

It is important to note that the described insulating bubble wrap exhibits beneficial heat seal characteristics where the preferably clear polyethylene cap layer surface is highly heat sealable, while the metalized high melt surface is generally not heat sealable. Such properties create significant advantages when this material is used in a converting process that requires selective heat sealing of stacked layers.

Process for Preparing Insulating Bubble Wrap.

To manufacture the insulating bubble wrap of the present subject matter, a first polyethylene film is first fed to a heated roll system comprising a first vacuum roller comprising dimples and a second roller, wherein the first vacuum roller contacts the first polyethylene film, thereby forming a bubble film layer cap having a top side and an unsealed bottom side. A metallized polyethylene film comprising a first metallized side and a second non-metallized side is also fed to the heated roll system, wherein the second non-metallized side contacts the unsealed bottom side of the bubble layer, thereby forming a sealed bubble layer comprising a top side. In this process, the polyethylene material used as the metallized polyethylene film layer and the polyethylene film bubble cap layer are as described above.

In this manufacturing process, in a preferred embodiment, the insulating bubble wrap (see Figure III) is produced in a process where both the base metallized polyethylene layer and polyethylene bubble film cap layer of thermoplastic film are introduced into the machinery while threaded through a series of rollers; where the cap “bubbles” are sealed to the base opposite the reflective side (See Figure III).

Subsequently, these films are unwound into a web, where the bottom layer is a metallized, white tinted film with metallization on one side represented by a bottom web and a preferable clear cap layer represented by a top web. These webs are heated to a softer state, facilitating bonding and thermoforming. Specifically, the web that will become the cap layer is then introduced to a roller with a series of concave impressions that provide a vacuum or suction effect that produces impressions or concavities on this cap layer. While such a cap layer is in a softened and heated form, the heated bottom layer is applied with the non-metallized surface oriented toward the clear film and reflective (metallized) surface facing away, and the two are sealed together while maintaining the encapsulation of the top layer film while creating a series of hermetic seals of caps to the base film.

The preparation process is illustrated in Figure III where a base layer and top layer film are heated, thermoformed and combined into a bubble wrap structure with a smooth base side and a bubble side with many encapsulated bubbles on its surface.

Component N of Figure II is a polyethylene film with metallization on one side, produced by the resins described above and specially formulated to possess enable good reflective application, resulting in good vapor barrier properties and heat reflectivity, while having relatively greater heat resistance and rigidity to facilitate web feeding in a converting processes to create packaging products. As discussed above, such a film can be metallized using vacuum metallization; a process that applies metallized surface onto the film.

The process described in the disclosure of the present subject matter may be practiced using existing equipment as in conventional practice where polyester films are used. One possible manufacturing method for the material described in the disclosure of the present subject matter uses machinery that is designed for bubble wrap manufacturing, using thermoplastic film instead of thermoplastic resins or pellets that are extruded (See Figure II). The method of manufacturing described in the present subject matter is introduced here, where instead of using a top laminate layer of dissimilar resin metallized film (Figure I), Item M, in a preferred form, the bottom layer or base layer film is itself metallized to provide the metallized surface. Since this base metallized film can be manufactured using similar chemical origin or complementary materials as the cap layer, this combined insulating bubble wrap structure and downstream products made using it need not be recycled in a facility that accepts mixed plastics, and can more easily contain additives that facilitate their breakdown when polyethylene varieties are utilized.

In another embodiment, an additional processing step can be incorporated in the above process where a second metallized polyethylene film comprising a first metallized side and a second non-metallized side is applied to the top side of the sealed bubble layer, wherein the second non-metallized side contacts the top side of the sealed bubble layer.

In yet another embodiment a non-reflective base and bubble layer can be combined with a higher heat resistance, metalized film layer that is affixed to the top of the bubble layer. This unique top layer material is made of a heat resistant material of similar chemical origin material to the base and bubble layer, preferably polyethylene, which act as the sealant layer. The higher heat resistant metalized top layer facilitates where heat is applied facilitating the heat seal and manufacture of articles made of the same while providing facilitated recycling of articles made of the material.

Shield Layer

Recycling and sorting facilities often utilize detectors such as metal, optical and infrared detectors to identify certain types of materials in the recycled stream they are processing. Optical sorting and infrared detectors are used to identify the chemical makeup of materials during recycling sorting. Metal detectors look for a ‘metal signature;’ for example, a large piece of steel on a conveyor has a large metal signature. However, because some recycling facilities may falsely reject metallized films due to the fact that they employ metal detectors that prevent the entry of harmful metal objects, a method of shielding has been developed to allow the use of the relatively harmless metallized film of the present subject matter in such recycling facilities. The method of shielding, altering the detection or otherwise reducing the detectability of the metallization of the films described in this specification can improve the recyclability of the described packaging products at such facilities by eliminating the response of a metal detector. RFID stickers can be used as a way to identify the subject articles as safe to recycle or to otherwise help with their sorting.

In the same light, identifiers may be applied to the subject insulating packaging products to increase their detection to also allow them to generally escape rejection within a recycling facility. Such identifiers may require cooperation with specialized hardware in the sorting process.

The insulating bubble wrap described above can thus further comprise a shield layer attached to the metallized side of the metallized polyethylene layer. Typically, the shield layer is a thermoplastic. Preferably, the thermoplastic is polypropylene. More preferably, the shield layer is biaxially oriented polypropylene (BOPP). When present, the shield layer is applied to the metallized side of the metallized polyethylene layer where at least one of the metallized polyethylene layer and the polyethylene bubble film cap layer further comprise at least one biodegradation additive. Additionally, although the base metallized films are tinted white before metallization, any color film, including clear can be used.

In an alternative embodiment, a third laminate metallized layer can be applied to the top of the film bubble cap using the polyethylene material described above, while maintaining the various features promoting recyclability and biodegradability as described above. An example includes metallized polyethylene laminated onto a polyethylene bubble base and cap. Although, this method does not introduce a net reduction in necessary layers, it does provide an environmentally friendly insulating material.

An additional advantage of using the metallized polyethylene layer described above as a substitute for metallized polyester, is that the heating process used in the manufacturing process of the insulating bubble film creates a stretching of the material that creates a dulling effect. Such a dulling or matting effect serves to provide a unique appearance to such an insulating material and may further help in its marketing and contribute to its environmentally friendly characteristics. The stretching can also serve to lower the metal signature of the article made from the film, as discussed above.

Alternative embodiments to those described above include the insulating bubble wrap that is metallized on both surfaces using a method of employing the metallized base layer as well a metallized third layer, although metallization can make heat sealing required for pouches or the like, difficult or impossible. Also, metallized bubble cap layers can be used. Preferably, the metallized surfaces described above appear on the surface that will face the heat source of the protected package. However, in alternate embodiments, the films described herein can be metallized on either or both surfaces, however, ideally metallized films are heat sealable only on the opposite side and where the bubble is attached, and the entire structure is not heat sealable. The stability of the process of the current subject matter applies to the film not shriveling up when heat is applied. Although the reflective surfaces of such films are preferred to be oriented the heat source, the metallization when in alternative position, provides vapor barrier properties that can enhance the protective quality of the material and downstream products.

In other alternative methods, the method of producing the insulating material may include a combined method of extrusion and the use of flat film stock. For example, a specialized flat film metallized on one side can be fed into a bubble manufacturing machine that extrudes film forming the cap layer onto it, transforming it into a bottom layer of a bubble wrap structure, with one metallized side. Alternatively, a metallized or metal-containing layer can be extruded and act as one or multiple of the layers of the insulating film. An additional format includes the use of multiple layers of bubble film bonded together.

Biodegradability

The insulating bubble wrap of the present subject matter may also incorporate additives that enhance the environmental friendliness of the material by increasing its ability to degrade post-disposal. One such additive is BDA, that contributes to the oxidation and more rapid breakdown of polyethylene film. Such additives can be utilized in the manufacture of both the metallized polyethylene base and polyethylene film cap structures described above; therefore resulting in a total structure including downstream products that are themselves partially biodegradable, compostable or oxo-biodegradable.

Biodegradability properties for films of the present subject matter refers to the breakdown of the films themselves i.e. the metal portions of the films do not break down and therefore such materials and products containing them are not completely biodegradable when any component they contain is metallized.

Other versions of the prior structure may include the use of resins that are themselves biodegradable, such as plant-based resins, which behave rather similarly to polyethylene film in their melt and heat seal characteristics. Such films when utilized as substitutes in the base, cap and/or metallized structures above introduce additional insulating bubble wrap structures that are partially biodegradable.

As described above, one benefit of the subject matter of the present disclosure relates to the use of polyethylene material having similar properties throughout the structure as described above to aid disposal. However, in an alternate embodiment, the facilitated recycling can be achieved by using a variety of films made using chemically similar resins that need not be identical in nature; although, there is emphasis on melting points. Alternatively, any combination of film types featuring various melt points can be used to achieve a material that is easier to recycle that those with the title “Mixed Plastics.” Also, the polyethylene materials described above can be substituted by utilizing additives that create similar favorable characteristics described as facilitating the manufacture of environmentally friendly insulating packaging. However, in any event, all films included in the bubble film wrap structure, whether including additives or other resins, will have a difference in melting point temperature of no greater than 179° F., preferably, no greater than 78° F., more preferably, no greater than 27° F., even more preferably, 15° F., and most preferably, 10° F.

Production of Articles from Insulating Wrap

The process for converting roll form easily recyclable insulation material; such as metallized polyethylene bubble film, into a pouches, box liners, pallet covers or shopping bags, involves loading rolls of insulation material onto specialized bag or pouch converting machines that can unwind, combine, heat seal, cut and segment multiple roll or single rolls of the material into various selected sizes of finished goods. Heat sealing preferable occurs with two surfaces of non-metallized bubble contacting one another.

In the manufacture of a pouch, a single roll of insulation material can be loaded onto a converting machine. Then, the insulated bubble wrap material is unwound, fed into a folding device, heat sealed at the selected length using a heat seal method that seals while cutting or burning. Alternatively, a heat seal combined with a cutting device or subsequent step involving a cutting device is used to create units the product.

The first step is loading the rolls onto a shaft, then the material is folded while it is advanced, a heat sealing wire or constant heat bar performs a transverse heat seal while a cutting using knife or burning hot wire segments the pouch into individual pieces.

The process of converting such insulation material into a gusseted square bottom bag involves a similar process where, in a preferred embodiment, three rolls of insulation material are loaded onto a machine. A top layer that will become the side of a bag, a folded bottom gusset and a bottom layer that will become the other side of the bag. Such rolls will be unwound into webs that will later generate the top side, bottom gusset, and bottom side of a bag that opens into a three-dimensional insulating box liner. Similar to the pouch, the various film webs are selectively heat sealed to one another by applying heat seals in the longitudinal machine direction, parallel to film movement, at 45 degrees for gusseting that results in a square bottom and transverse that seals the ends of the bag. This process is also accompanied by a cutting step that can happen simultaneously or separately. A key feature of the invention is that the specialized insulating bubble wrap described above can be utilized to manufacture products that require the heating sealing of stacked layers such as that used in the manufacture of gusseted square bottom bags. Such stacked layers will require selective heat sealing, wherein when heat is applied, not all layers must seal together, and generally the metalized surfaces that are in contact with one another need not be heat sealed but the bubble cap layers do. Advantageously, the high melt points and metalized surface of the special insulating bubble wrap both help to reduce the inadvertent heat seal of surfaces that needed not be heat sealed. If certain low melt or resulting lesser metalized varieties of film do exhibit such unfavorable heat sealing, separators can be introduced in the converting process, that prevent the contact and heat seal of such surfaces or otherwise facilitate the converting process by preventing contact of those surfaces.

The steps described above can occur in any order, and seal or cut methods can be achieved using any combination of heat sealing, burning or mechanical cutting methods. Also, the number of rolls of insulating material utilized to create an insulating packaging product can be fewer or greater by using alternative combining methods and or cutting methods. Multiple quantities of packaging products can be manufactured by utilizing multiple sets of rolls of insulating material.

Alternatives to heat sealing are sonic welding or other attaching methods involving heat. Additionally, the aforementioned higher melt characteristics are helpful when the insulating bags and other packaging products are manufactured manually in that heat seals are also used in such methods. Box liners can also be manufactured without gusseting.

An alternative format of manufacture is the direct feed of films from the aforementioned bubble manufacturing process into the converting process, while skipping the roll format. Such a process introduces rather large efficiencies in manufacturing since when utilized in the converting process, the use of rolls requires a time tedious process of changing rolls when they are used completely.

Other features, advantages and embodiments of the invention disclosed herein will be readily apparent to those exercising ordinary skill after reading the foregoing disclosure. In this regard, while specific embodiments of the invention have been described in considerable detail, variations and modifications of these embodiments can be affected without departing from the spirit and scope of the invention as described and claimed.

What is claimed is:

1. An insulating bubble wrap comprising a metallized polyethylene layer having a first metallized side, a second non-metallized side, and a metal thickness; and a polyethylene bubble film cap layer attached to the metallized polyethylene along the second non-metallized side.

2. The insulating bubble wrap of claim 1 wherein the metal of the metallized polyethylene layer is aluminum.

3. The insulating bubble wrap of claim 1 wherein the metal thickness is 10 to 50 microns.

4. The insulating bubble wrap of claim 1 wherein the polyethylene bubble film cap layer is attached to the metallized polyethylene layer by heat bonding.

5. The insulating bubble wrap of claim 1 wherein the metallized polyethylene layer comprises polyethylene having a density of 0.910 to 0.965 g/cc.

6. The insulating bubble wrap of claim 5 wherein the polyethylene is a copolymer of ethylene with an alpha-olefin CH₂═CHR, wherein R is an alkyl radical containing from 1 to 18 atoms of carbon.

7. The insulating bubble wrap of claim 6 wherein the alpha-olefin is hexene.

8. The insulating bubble wrap of claim 5 wherein the polyethylene has a melting point of 225° F. to 230° F.

9. The insulating bubble wrap of claim 1 wherein the polyethylene bubble film cap layer comprises polyethylene having a density of 0.910 g/cc to 0.965 g/cc.

10. The insulating bubble wrap of claim 9 wherein the polyethylene is a copolymer of ethylene with an alpha-olefin CH₂═CHR, wherein R is an alkyl radical containing from 1 to 18 atoms of carbon.

11. The insulating bubble wrap of claim 10 wherein the alpha-olefin is hexene.

12. The insulating bubble wrap of claim 9 wherein the polyethylene bubble film layer has: a melting point of 225° F. to 230° F.

13. The insulating bubble wrap of claim 1 wherein the thickness of metallized polyethylene layer is from 0.80 to 0.90 mils.

14. The insulating bubble wrap of claim 1 wherein the polyethylene bubble film cap layer has a thickness of 0.7 to 2.5 mils.

15. A process for producing a bubble wrap comprising:
(1) feeding a first polyethylene film to a heated roll system comprising a first vacuum roller comprising dimples and a second roller, wherein the first vacuum roller contacts the first polyethylene film, thereby forming a bubble layer having a top side and an unsealed bottom side;
(2) feeding a metallized polyethylene film comprising a first metallized side and a second non-metallized side to the heated roll system, wherein the second non-metallized side contacts the unsealed bottom side of the bubble layer, thereby forming a sealed bubble layer comprising a top side.

16. The process of claim 15 wherein the layer applied to the unsealed bubble side is not metalized, and a metallized polyethylene film comprising a first metallized side and a second non-metallized side is applied to the top side of the sealed bubble layer, wherein the non-metallized side contacts the top side of the sealed bubble layer.

17. The process of claim 15 further comprising adding a third layer of non-metalized polyethylene film to the bubble wrap.

18. The insulating bubble wrap of claim 1 wherein at least one of the metallized polyethylene layer and the polyethylene bubble film cap layer are made of tinted base films.

19. The insulated bubble wrap of claim 18 wherein the tint is white.

20. An article comprising the insulated bubble wrap of claim 1, the article being selected from pouches, box liners, pallet covers or shopping bags.
